(19) United States
(12) Patent Application Publication
(10) Pub. No.: US 2011/0016393 A1
(43) Pub. Date: Jan. 20, 2011

(54) RESERVING MEMORY TO HANDLE MEMORY ALLOCATION ERRORS

(75) Inventor: Nikolaus Gerteis, Horst (DE)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/506,096

(22) Filed: Jul. 20, 2009

(51) Int. Cl. G06F 3/048; G06F 12/00; G06F 12/02

(52) U.S. Cl. 715/716; 711/170

(57) ABSTRACT

A computer implemented method for reserving memory to handle memory allocation errors is disclosed. The method can include reserving, by a processor, a first and second reserve memory in a memory storage device in response to initiating a graphical user interface for managing a project. Thereafter, the method can provide for releasing, by the processor, the first reserve memory in response to receiving a first memory allocation error. A warning message regarding the memory allocation error can be displayed. Furthermore, upon receiving a second memory allocation error, a second reserve memory can be released. Subsequently, upon termination of the graphical user interface, the project is saved.

### FIELD

The following relates to computing devices, and more particularly for reserving memory to handle memory allocation errors.

### BACKGROUND

Computer systems can require memory. If a computer system requests to allocate memory for operation, an error can occur if enough memory is not available. One example of a computer system that can utilize a method to handle memory allocation errors is a digital audio workstation (DAW). The DAW can display a graphical user interface (GUI) to allow a user to manipulate files on tracks. The DAW can display each element of a musical arrangement, such as a guitar, microphone, or drums, on separate tracks. For example, a user may create a musical arrangement with a guitar on a first track, a piano on a second track, and vocals on a third track. The DAW can further break down an instrument into multiple tracks. For example, a drum kit can be broken into multiple tracks with the snare, kick drum, and hi-hat each having its own track. By placing each element on a separate track a user is able to manipulate a single track, without affecting the other tracks. For example, a user can adjust the volume or pan of the guitar track, without affecting the piano track or vocal track. As will be appreciated by those of ordinary skill in the art, using the GUI, a user can apply different effects to a track within a musical arrangement. For example, volume, pan, compression, distortion, equalization, delay, and reverb are some of the effects that can be applied to a track.

Typically, a DAW works with two main types of files: MIDI (Musical Instrument Digital Interface) files and audio files. MIDI is an industry-standard protocol that enables electronic musical instruments, such as keyboard controllers, computers, and other electronic equipment, to communicate, control, and synchronize with each other. MIDI does not transmit an audio signal or media, but rather transmits “event messages” such as the pitch and intensity of musical notes to play, control signals for parameters such as volume, vibrato and panning, cues, and clock signals to set the tempo. As an electronic protocol, MIDI is notable for its widespread adoption throughout the industry.

Using a MIDI controller coupled to a computer, a user can record MIDI data into a MIDI track. Using the DAW, the user can select a MIDI instrument that is internal to a computer and/or an external MIDI instrument to generate sounds corresponding to the MIDI data of a MIDI track. The selected MIDI instrument can receive the MIDI data from the MIDI track and generate sounds corresponding to the MIDI data which can be produced by one or more monitors or speakers. For example, a user may select a piano software instrument on the computer to generate piano sounds and/or may select a tenor saxophone instrument on an external MIDI device to generate saxophone sounds corresponding to the MIDI data. If MIDI data from a track is sent to an internal software instrument, this track can be referred to as an internal track. If MIDI data from a track is sent to an external software instrument, this track can be referred to as an external track.

Audio files are recorded sounds. An audio file can be created by recording sound directly into the system. For example, a user may use a guitar to record directly onto a guitar track or record vocals, using a microphone, directly onto a vocal track. As will be appreciated by those of ordinary skill in the art, audio files can be imported into a musical arrangement. For example, many companies professionally produce audio files for incorporation into musical arrangements. In another example, audio files can be downloaded from the Internet. Audio files can include guitar riffs, drum loops, and any other recorded sounds. Audio files can be in sound digital file formats such as WAV, MP3, M4A, and AIFF. Audio files can also be recorded from analog sources, including, but not limited to, tapes and records.

Many times in working with a DAW, a particular proprietor provides the primary software for creating and managing musical arrangements. However, in addition to the primary software, other software programs and applications can be integrated with the primary software which can provide additional functionalities. These additional software programs are oftentimes provided by third party developers. Accordingly, these are generally known as third party plug-ins. Third party plug-ins are available for other computer systems as well, such as video editing and photo editing.

In complex software applications such as musical arrangement programs having third party plug-ins, it is not uncommon to run out of memory. When the DAW runs out of memory, the program can crash and data can be lost.

Moreover, with respect to third party plug-ins, the code may not be available for the programmer of the primary musical arrangement software to modify. Accordingly, third party plug-ins may not interact with the primary software correctly such that sufficient free memory is adequately monitored or taken into account.

### SUMMARY

As introduced above, reserving memory prior to receiving a memory allocation error can allow a user to protect a project, such as a musical arrangement, on a computer. A computer implemented method for reserving memory is disclosed. The method can include initiating a graphical user interface. The method can further include reserving a first and a second reserve memory in a memory storage device in response to initiating the graphical user interface. In response to receiving a first memory allocation error, the method can include releasing, by the processor, the first reserve memory as well as displaying a warning message regarding the memory allocation error. Additionally, in response to a second memory allocation error, the method can include releasing the second reserve memory in order to prevent a memory error and save the project. After saving the project, the graphical user interface can be terminated. Although described with reference to a DAW, other computer and software systems can implement this memory allocation method.

Many other aspects and examples will become apparent from the following disclosure.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system having a DAW musical arrangement in accordance with an exemplary embodiment;

FIG. 2 depicts a screenshot of a GUI of a DAW displaying a musical arrangement including MIDI and audio tracks in accordance with an exemplary embodiment;

FIG. 3 illustrates a flow chart diagram of a method for allocation of reserve memory in accordance with an exemplary embodiment; and

FIG. 4 illustrates a flow chart diagram of a method for re-allocation of reserve memory in accordance with an exemplary embodiment.

### DETAILED DESCRIPTION

The functions described as being performed at various components can be performed at other components, and the various components can be combined and/or separated. Other modifications also can be made.

Thus, the following disclosure ultimately will describe systems, computer readable media, devices, and methods for reserving memory to handle allocation errors. Many other examples and other characteristics will become apparent from the following description. The systems, computer readable media, devices, and methods for reserving memory to handle allocation errors described herein are discussed in reference to a DAW. However, these systems, computer readable media, and devices are applicable to any computer software system that allocates memory for operation.

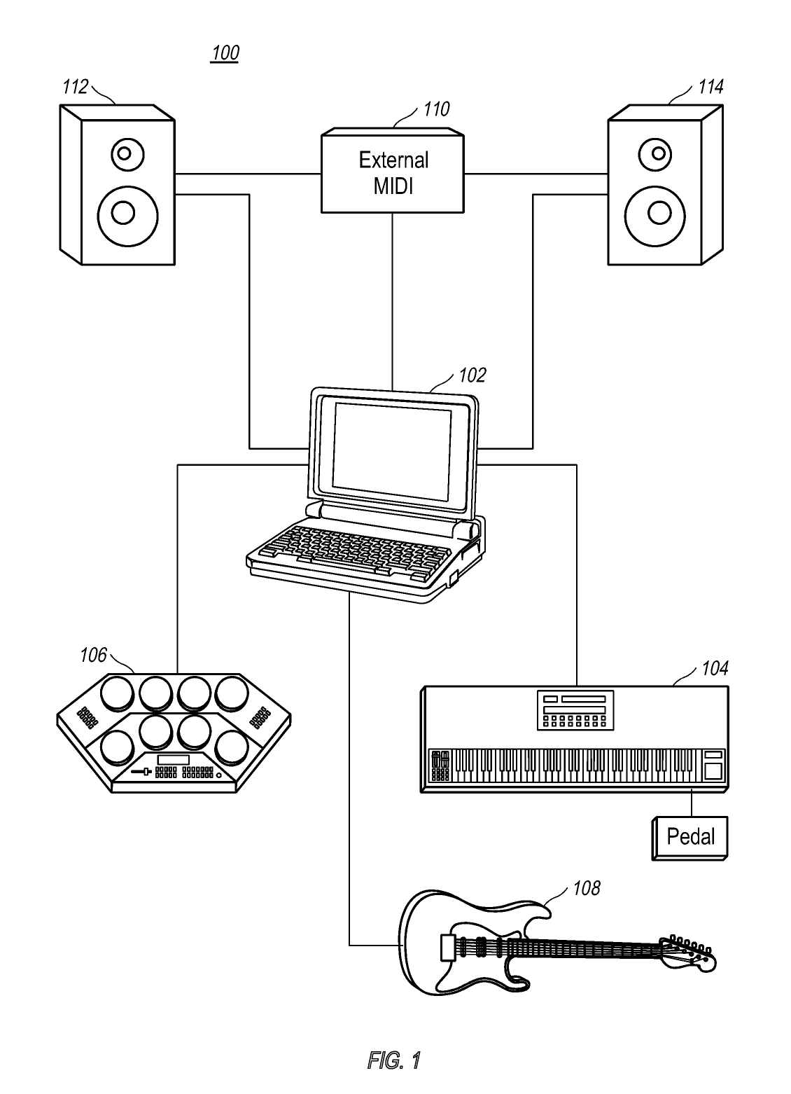

Referring to FIG. 1, a block diagram of a system including a DAW in accordance with an exemplary embodiment is illustrated. As shown, the system 100 can include a computer 102, one or more sound output devices 112, 114, one or more MIDI controllers (e.g. a MIDI keyboard 104 and/or a drum pad MIDI controller 106), one or more instruments (e.g. a guitar 108, and/or a microphone (not shown)), and/or one or more external MIDI devices 110. As would be appreciated by one of ordinary skill in the art, the musical arrangement can include more or less equipment as well as different musical instruments.

The computer 102 can be a data processing system suitable for storing and/or executing program code, e.g., the software to operate the GUI which together can be referred to as a, DAW. The computer 102 can include at least one processor, e.g., a first processor, coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters. In one or more embodiments, the computer 102 can be a desktop computer or a laptop computer.

A MIDI controller is a device capable of generating and sending MIDI data. The MIDI controller can be coupled to and send MIDI data to the computer 102. The MIDI controller can also include various controls, such as slides and knobs, that can be assigned to various functions within the DAW. For example, a knob may be assigned to control the pan on a first track. Also, a slider can be assigned to control the volume on a second track. Various functions within the DAW can be assigned to a MIDI controller in this manner. The MIDI controller can also include a sustain pedal and/or an expression pedal. These can affect how a MIDI instrument plays MIDI data. For example, holding down a sustain pedal while recording MIDI data can cause an elongation of the length of the sound played if a piano software instrument has been selected for that MIDI track.

As shown in FIG. 1, the system 100 can include a MIDI keyboard 104 and/or a drum pad controller 106. The MIDI keyboard 104 can generate MIDI data which can be provided to a device that generates sounds based on the received MIDI data. The drum pad MIDI controller 106 can also generate MIDI data and send this data to a capable device which generates sounds based on the received MIDI data. The MIDI keyboard 104 can include piano style keys, as shown. The drum pad MIDI controller 106 can include rubber pads. The rubber pads can be touch and pressure sensitive. Upon hitting or pressing a rubber pad, or pressing a key, the MIDI controller (104,106) generates and sends MIDI data to the computer 102.

An instrument capable of generating electronic audio signals can be coupled to the computer 102. For example, as shown in FIG. 1, an electrical output of an electric guitar 108 can be coupled to an audio input on the computer 102. Similarly, an acoustic guitar 108 equipped with an electrical output can be coupled to an audio input on the computer 102. In another example, if an acoustic guitar 108 does not have an electrical output, a microphone positioned near the guitar 108 can provide an electrical output that can be coupled with an audio input on the computer 102. The output of the guitar 108 can be coupled to a pre-amplifier (not shown) with the pre-amplifier being coupled to the computer 102. The pre-amplifier can boost the electronic signal output of the guitar 108 to acceptable operating levels for the audio input of computer 102. If the DAW is in a record mode, a user can play the guitar 108 to generate an audio file. Popular effects such as chorus, reverb, and distortion can be applied to this audio file when recording and playing.

The external MIDI device 110 can be coupled to the computer 102. The external MIDI device 110 can include a processor, e.g., a second processor which is external to the first processor 102. The external processor can receive MIDI data from an external MIDI track of a musical arrangement to generate corresponding sounds. A user can utilize such an external MIDI device 110 to expand the quality and/or quantity of available software instruments. For example, a user may configure the external MIDI device 110 to generate electric piano sounds in response to received MIDI data from a corresponding external MIDI track in a musical arrangement from the computer 102.

The computer 102 and/or the external MIDI device 110 can be coupled to one or more sound output devices (e.g., monitors or speakers). For example, as shown in FIG. 1, the computer 102 and the external MIDI device 110 can be coupled to a left monitor 112 and a right monitor 114. In one or more embodiments, an intermediate audio mixer (not shown) may be coupled between the computer 102, or external MIDI device 110, and the sound output devices, e.g., the monitors 112, 114. The intermediate audio mixer can allow a user to adjust the volume of the signals sent to the one or more sound output devices for sound balance control. In other embodiments, one or more devices capable of generating an audio signal can be coupled to the sound output devices 112, 114. For example, a user can couple the output from the guitar 108 to the sound output devices.

The one or more sound output devices can generate sounds corresponding to the one or more audio signals sent to them. The audio signals can be sent to the monitors 112, 114 which can require the use of an amplifier to adjust the audio signals to acceptable levels for sound generation by the monitors 112, 114. The amplifier in this example may be internal or external to the monitors 112, 114.

Although, in this example, a sound card is internal to the computer 102, many circumstances exist where a user can utilize an external sound card (not shown) for sending and receiving audio data to the computer 102. A user can use an external sound card in this manner to expand the number of available inputs and outputs. For example, if a user wishes to record a band live, an external sound card can provide eight (8) or more separate inputs, so that each instrument and vocal can each be recorded onto a separate track in real time. Also, disc jockeys (djs) may wish to utilize an external sound card for multiple outputs so that the dj can cross-fade to different outputs during a performance.

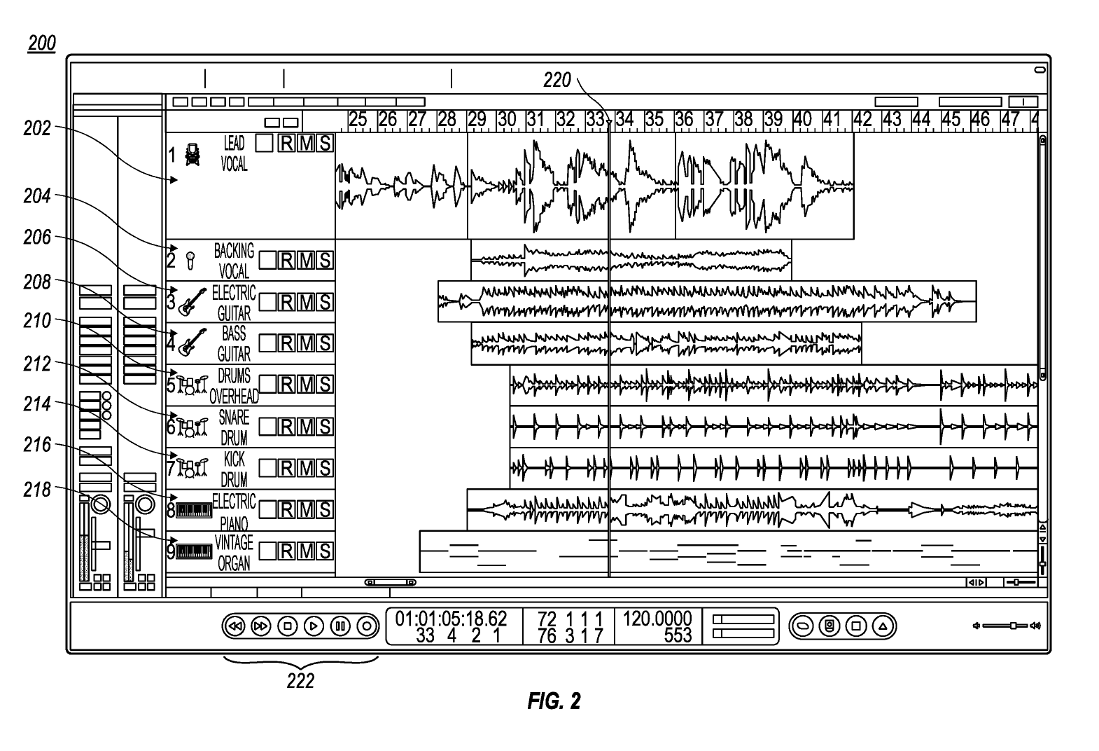

Referring to FIG. 2, a screenshot of a musical arrangement in a GUI of a DAW in accordance with an exemplary embodiment is illustrated. The musical arrangement 200 can include one or more tracks with each track having one or more of audio files or MIDI files. Generally, each track can hold audio or MIDI files corresponding to each individual desired instrument. As shown, the tracks are positioned horizontally. A playhead 220 moves from left to right as the musical arrangement is recorded or played. As one of ordinary skill in the art would appreciate, other tracks and playhead 220 can be displayed and/or moved in different manners. The playhead 220 moves along a timeline that shows the position of the playhead within the musical arrangement. The timeline indicates bars, which can be in beat increments. For example as shown, a four (4) beat increment in a 4/4 time signature is displayed on a timeline with the playhead 220 positioned between the thirty-third (33rd) and thirty-fourth (34th) bar of this musical arrangement. A transport bar 222 can be displayed and can include commands for playing, stopping, pausing, rewinding and fast-forwarding the displayed musical arrangement. For example, radio buttons can be used for each command. If a user were to select the play button on transport bar 222, the playhead 220 would begin to move down the timeline, e.g., in a left to right fashion.

As shown, the lead vocal track, 202, is an audio track. One or more audio files corresponding to a lead vocal part of the musical arrangement can be located on this track. In this example, a user has directly recorded audio into the DAW on the lead vocal track. The backing vocal track, 204 is also an audio track. The backing vocal track 204 can contain one or more audio files having backing vocals in this musical arrangement. The electric guitar track 206 can contain one or more electric guitar audio files. The bass guitar track 208 can contain one or more bass guitar audio files within the musical arrangement. The drum kit overhead track 210, snare track 212, and kick track 214 relate to a drum kit recording. An overhead microphone can record the cymbals, hit-hat, cow bell, and any other equipment of the drum kit on the drum kit overhead track. The snare track 212 can contain one or more audio files of recorded snare hits for the musical arrangement. Similarly, the kick track 214, can contain one or more audio files of recorded bass kick hits for the musical arrangement. The electric piano track 216 can contain one or more audio files of a recorded electric piano for the musical arrangement.

The vintage organ track 218 is a MIDI track. Those of ordinary skill in the art will appreciate that the contents of the files in the vintage organ track 218 can be shown differently because the track contains MIDI data and not audio data. In this example, the user has selected an internal software instrument, a vintage organ, to output sounds corresponding to the MIDI data contained within this track 218. A user can change the software instrument, for example to a trumpet, without changing any of the MIDI data in track 218. Upon playing the musical arrangement the trumpet sounds would now be played corresponding to the MIDI data of track 218. Also, a user can set up track 218 to send its MIDI data to an external MIDI instrument, as described above.

Each of the displayed audio and MIDI files in the musical arrangement as shown on screen 200 can be altered using the GUI. For example, a user can cut, copy, paste, or move an audio file or MIDI file on a track so that it plays at a different position in the musical arrangement. Additionally, a user can loop an audio file or MIDI file so that it is repeated, split an audio file or MIDI file at a given position, and/or individually time stretch an audio file for tempo adjustments.

A display window contains information for the user about the displayed musical arrangement. As shown, the current tempo in bpm of the musical arrangement is set to 120 bpm. The position of playhead 220 is shown to be at the thirty-third (33rd) bar beat four (4) in the display window. Also, the position of the playhead 220 within the song is shown in minutes, seconds etc.

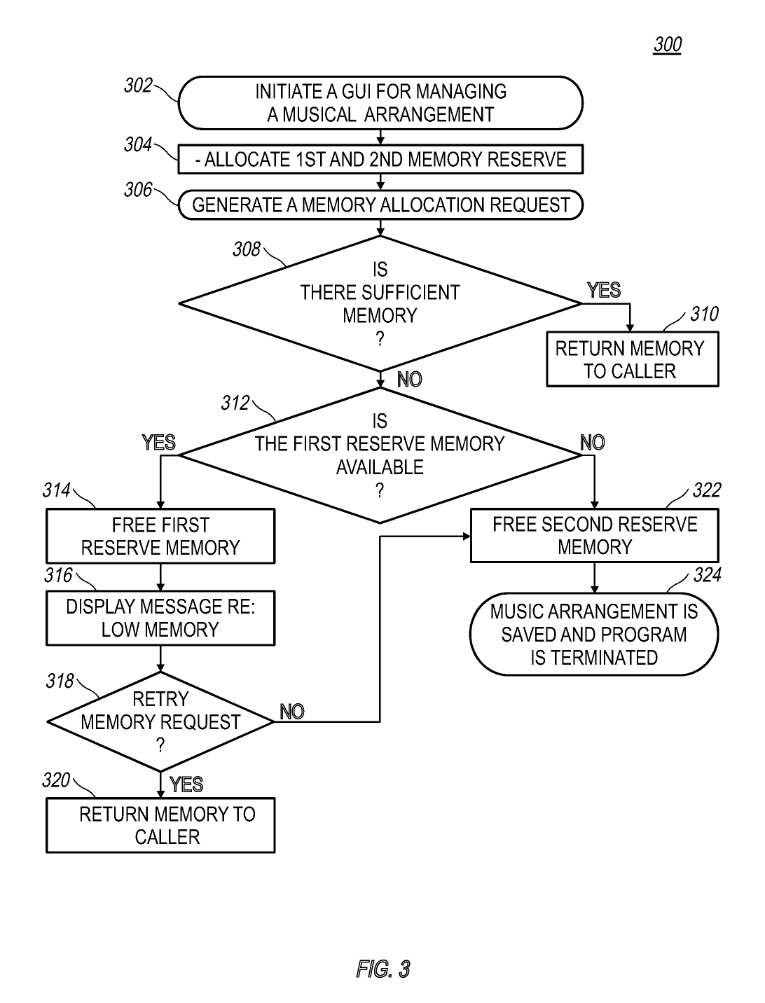

Referring to FIG. 3, a flow chart diagram 300 of a method for allocation of reserve memory in accordance with an exemplary embodiment is illustrated. The exemplary method 300 is provided by way of example, as there are a variety of ways to carry out the method. In one or more embodiments, the method 300 is performed by the computer 102 of FIG. 1. The method 300 can be executed or otherwise performed by one or a combination of various systems. The method 300 described below can be carried out using the devices illustrated in FIG. 1 by way of example, and various elements of this figure are referenced in explaining exemplary method 300. Each block shown in FIG. 3 represents one or more processes, methods or subroutines carried out in exemplary method 300. The exemplary method 300 can begin at block 302.

At block 302, a GUI for managing a musical arrangement on a DAW can be initiated. For example, using a navigation device, e.g., a mouse, a user can click on an icon to open the musical arrangement software on the DAW. In response to the clicking on the mouse, the processor or processor module of computer 102 can start the musical arrangement software. The processor or a display module of computer 102 can display the GUI. Although described with reference to a DAW, the initiated GUI and blocks of FIG. 3 can be for managing a project other than a musical arrangement. After initiating the GUI, the method 300 can proceed to block 304.

At block 304, allocated memory is reserved. For example, the processor or processor module of computer 102 can reserve memory. There can be two allocated memory reserves, e.g., a first reserve memory and a second reserve memory. The first reserve memory and second reserve memory can be the same amount or can be different amounts of memory. In systems where the memory allocation method is different from a default allocation method, the added memory allocation method can disable the previous memory allocation method. Reserving the memory can allow the GUI to properly save a musical arrangement in response to a memory allocation error. The amount of memory that is reserved can be predetermined.

In this example, the method 300 reserves memory, e.g., a block of memory, and keeps it essentially free from data. Accordingly, during normal operation of the DAW, no data is saved in the reserve memory unless a memory allocation error occurs. The reserve memory can be kept free so that it can be released in case the DAW runs out of memory and generates an allocation error. If there is a memory allocation error, the reserve memory can then be freed for use so that the memory allocation can be performed. With the additional freed memory, it is expected that the memory allocation request will be successful.

The first and second reserve memory should be of sufficient size so that in case of any memory allocation error, the freeing of the first reserve memory and/or second reserve memory can lead to a successful allocation after retrying the allocation. The amount of reserve memory should also not be so large as to interfere with the working of the DAW or to cause an increase in memory allocation errors.

Furthermore, a third party plug-in can be installed as an add-on to the primary musical arrangement software program. The third party plug-in used herein encompasses any software program, system, application, or object by a third party developer which is separately installed and integrated with the original music arrangement software. For example, such plug-ins may be programs which enable the use of virtual synthesizers or samplers. Plug-ins can mimic the sound of famous or vintage synthesizers. Additional plug-ins may include other virtual instruments such as piano, guitars or drums. Moreover, some plug-ins may provide certain effects, such as reverb, phaser, or distortion effects. Additionally, monitoring effects may be provided, such as a visual indication of an input signal prior to processing the audio. As these are merely illustrative examples, there are numerous other instruments, effects, and monitoring plug-ins. After reserving the memory, the method 300 can proceed to block 306.

Returning to FIG. 3, at block 306, a memory allocation request is generated by the program, plug-in, or system. The request can include an amount of memory that will be needed. The memory request can be the same command as used for the original allocation function. The original allocation function can be the function by which the DAW allocates memory in response to requests due to running programs and applications. Such an original allocation function can be the typical manner in which the DAW handles memory requirements. As the musical arrangement software is used, memory is required by the program, plug-in, or system. For example, the processor or processor module of the computer 102 receives a request for memory by the program, plug-in or system. The request can be generated in response to a user importing a plug-in. Additionally, the plug-ins discussed above can have a particular memory requirement that is imposed on the DAW. Accordingly, sufficient memory is required to run the plug-ins. After generating a memory allocation request, the method 300 can proceed to block 308.

At block 308, a determination is made whether there is sufficient memory available. For example, the processor or processor module of the computer 102 can determine if there is sufficient memory available based on the amount of available memory and the amount of memory that is requested. If there is sufficient available memory, then the memory is properly allocated and returned to the caller as indicated at block 310. For example, the processor or processor module of the computer 102 can return the memory to the caller. If there is not sufficient available memory, then the method 300 can proceed to block 312. If there is insufficient available memory, a memory allocation error or failure can be received. For example, if a third party plug-in is being used and has a large memory requirement, the available memory can be completely used. A memory allocation is received by the processor or processor module of computer 102. If there is not sufficient available memory, then the method 300 proceeds to block 312.

At block 312, a determination is made whether the first reserve memory is available. For example, the processor or processor module of computer 102 determines if the first reserve memory has been previously freed. One reason the reserve memory may no longer be free is if there has already been a memory allocation error, and the first reserve memory therefore has been previously released. Accordingly, if a second memory allocation error occurs, the first reserve memory may no longer be available for release. If the first reserve memory is not available, the method 300 can proceed to block 322. If the first reserve memory is available the method 300 can proceed to block 314.

At block 314, the first reserve memory is released or freed. For example, the processor or processor module of computer 102 can release the reserve memory to allow the DAW to use the reserve memory for the musical arrangement software and/or plug-ins. Accordingly, after release, the first reserve memory is no longer reserved and the total amount of available free memory is then increased by the size of the released memory.

At block 316, a message informing the user that the available memory is low is displayed. For example, the processor or display module of the computer 102 can cause the display of the message. The message can provide a warning to the user that the memory is low and can allow the user the opportunity to save the program and/or to free up additional memory. For example, the message can recite “Memory is getting low, you can still continue to work, but try to avoid adding plug-ins. If possible, remove any unused plug-ins.” After displaying the message, the method 300 can proceed to block 318.

At block 318, the memory request can be retried. For example, the processor or processor module of the computer 102 can send another request for memory. In other words, the DAW can attempt to again make a memory allocation as required by the programs and applications currently running. The processor or processor module of the computer 102 can determine if there is sufficient memory available based on the amount of available memory and the amount of memory that is requested. If there is sufficient available memory, then the memory is properly allocated and returned to the caller as indicated at block 320. For example, the processor or processor module of the computer 102 can cause the memory allocation. If there is not sufficient available memory, then the method 300 can proceed to block 322. If there is insufficient available memory, a memory allocation error or failure can be received. For example, if a third party plug-in is being used and has a large memory requirement, the available memory can be completely used. Thus, a memory allocation error is received.

At block 322, the second reserve memory is released. For example, in response to the second memory allocation error, the processor or processor module of computer 102 can release the second reserve memory. The purpose of releasing this reserve memory is to allow the musical arrangement to be saved. After releasing the reserve memory, the method 300 can proceed to block 324.

At block 324, the musical arrangement is saved and the musical arrangement program is terminated. For example, the processor or processor module of the computer 102 can cause the program to save the musical arrangement and can terminate the program. Blocks 322 and 324 allow for the musical arrangement to be saved. In conventional systems, the program could terminate prior to the musical arrangement being saved which could result in lost data, e.g., music. In addition, a message can be displayed informing the user of the events. For example, the processor or display module of computer 102 can cause a message to be displayed on the GUI which can read as: “There is not enough free memory to continue working with this project. Logic will quit now (you will be prompted to save any changes)”.

As discussed above, in method 300, two reserves memory are created. In response to a first memory allocation error, e.g., when there is insufficient available memory, the method 300 frees the first reserve memory. A warning message can be displayed to the user informing the user that there is low memory. As a result of the first memory allocation error and/or displayed message, the user may free-up memory. For example, the user can make more memory available by deleting files and/or closing plug-ins. As a result, enough memory can become available to re-allocate the first reserve memory (e.g. another first reserve memory). This re-allocation can allow another warning message to be displayed in response to another memory allocation error, e.g., a second memory allocation error. Using re-allocation can prevent the second memory reserve being freed and the program terminating in response to the next memory allocation error.

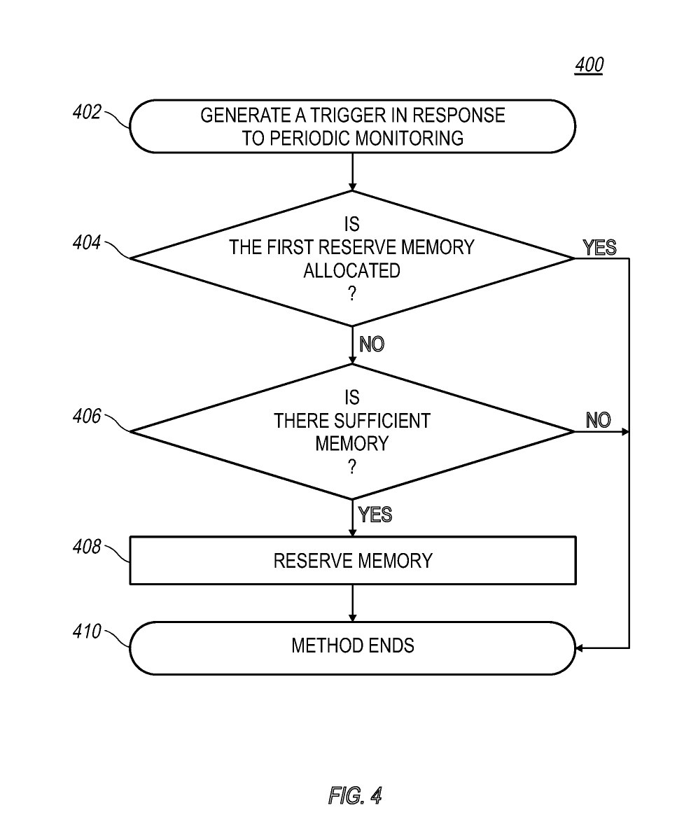

Referring now to FIG. 4, a flow chart diagram of a method for re-allocation of reserve memory in accordance with an exemplary embodiment is illustrated. The exemplary method 400 is provided by way of example, as there are a variety of ways to carry out the method. In one or more embodiments, the method 400 is performed by the computer 102 of FIG. 1. The method 400 can be executed or otherwise performed by one or a combination of various systems. The method 400 described below can be carried out using the devices illustrated in FIG. 1 by way of example, and various elements of this figure are referenced in explaining exemplary method 400. Each block shown in FIG. 4 represents one or more processes, methods or subroutines carried out in exemplary method 400. The exemplary method 400 can begin at block 402.

At block 402, a trigger can be generated in response to a system command and/or in response to a user command. For example, the processor or processor module of computer 102 can periodically monitor the amount of free memory and can generate the trigger in response to an increase in the availability of the memory. A change in memory can occur if a plug-in that reserves memory or another program that also reserves memory is closed, thereby freeing up the reserved memory. In addition, the user in response to the displayed message can free up memory by deleting one or more files and/or closing one or more plug-ins. After freeing the memory, in one example the user can request a re-allocation of memory. In this example, the user can click on an icon in the GUI requesting the re-allocation. After generating the trigger, the method 400 can proceed to block 404.

At block 404, a determination is made whether the first reserve memory is allocated in response to the trigger. The processor or processor module of computer 102 can determine if the first memory reserve has been allocated, e.g., previously released in response to an allocation error. If the first reserve memory has not been previously released, the method 400 proceeds to block 410 where the method 400 ends. If the first reserve memory has been previously released, the method 400 can proceed to block 406.

At block 406, a determination is made whether there is sufficient memory available to reserve memory, e.g., another first reserve memory. For example, the processor or processor module of computer 102 determines if there is sufficient memory for the first reserve memory based on the amount of available memory and the amount needed for the first reserve memory. The amount of memory needed for the first reserve memory can be a predetermined amount. If there is not sufficient available memory, then the method 400 can proceed to block 410 where the method 400 ends. If there is sufficient available memory, then the method 400 proceeds to block 408.

At block 408, memory is reserved, e.g., another first reserve memory is reserved. For example, the processor or processor module of computer 102 can reserve memory, e.g., the first reserve memory. The amount of the first reserve memory can be predetermined. Having another first reserve memory, allows the method to free this first memory reserve in response to a memory allocation error as done in block 314 of method 300 rather than freeing the second memory reserve as done in block 322 of method 300. After reserving the memory, the method 400 can proceed to block 410 where the method 400 ends.

The technology can take the form of an entirely hardware embodiment, an entirely software embodiment or an embodiment containing both hardware and software elements. In one embodiment, the invention can implemented in software, which includes but can not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers can not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized and/or distributed as known to those skilled in the art.

The above disclosure provides examples and aspects relating to various embodiments within the scope of claims, appended hereto or later added in accordance with applicable law. However, these examples are not limiting as to how any disclosed aspect may be implemented, as those of ordinary skill can apply these disclosures to particular situations in a variety of ways.

I claim:

1. A computer implemented method for reserving memory, the computer method comprising, in a processor:
reserving a first reserve memory and a second reserve memory in a memory storage device in response to initiating a graphical user interface for managing a project; and
releasing unused memory from the first reserve memory and second reserve memory prior to terminating the graphical user interface.

2. The method of claim 1, further comprising releasing the first reserve memory in response to receiving a first memory allocation error.

3. The method of claim 2, further comprising causing a display of a warning message in response to receiving the first memory allocation error.

4. The method of claim 2, further comprising:
determining whether the first reserve memory has been released in response to a trigger;
determining whether there is sufficient memory available in the event the first reserve memory has been released; and
reserving another first reserve memory in the event there is sufficient memory available.

5. The method of claim 2, further comprising releasing the second reserve memory in response to receiving a second memory allocation error.

6. The method of claim 5, further comprising terminating the graphical user interface after saving the project in response to receiving the second memory allocation error.

7. The method of claim 1, wherein the project is a musical arrangement implementing a third-party plug-in.

8. The method of claim 7, wherein the musical arrangement includes at least one of an audio file and MIDI file.

9. A computer program product for reserving memory, the computer program product comprising:
a computer-readable medium;
a display module residing on the computer-readable medium and operative to initiate and display a graphical user interface (GUI) associated with a musical arrangement; and
a processing module residing on the computer-readable medium and operative to reserve a first reserve memory and second reserve memory in a memory storage device in response to initiating the graphical user interface.

10. The computer program product of claim 9, wherein the processing module is operative to release the first reserve memory in response to receiving a first memory allocation error.

11. The computer program product of claim 10, wherein the display module is operative to cause the display of a warning message regarding the memory allocation error.

12. The computer program product of claim 10, wherein the processing module is operative to:
determine whether the first reserve memory has been released in response to a trigger;
determine whether there is sufficient memory available in the event the first reserve memory has been released; and
reserve another first reserve memory in the event there is sufficient memory available.

13. The computer program product of claim 10, wherein the processing module is operative to release the second reserve memory in response to receiving a second memory allocation error.

14. The computer program product of claim 13, wherein the processing module is operative to terminate the graphical user interface after saving the musical arrangement.

15. The computer program product of claim 10, wherein the musical arrangement implements a third-party plug-in.

16. The computer program product of claim 10, wherein the displayed musical arrangement includes at least one of an audio file and a MIDI file.

17. A system for reserving memory, the system comprising:
a display device for displaying a graphical user interface for managing a musical arrangement; and
a processor, communicatively coupled to the display device and operative to provide the graphical user interface for managing a musical arrangement,
the processor, communicatively coupled to at least one memory storage device and operative to reserve a first reserve memory and second reserve memory in the at least one memory storage device in response to initiation of the graphical user interface.

18. The system of claim 17, wherein the processor is operative to release the first reserve memory in response to receiving a first memory allocation error.

19. The system of claim 18, wherein the display device displays a warning message regarding the memory allocation error.

20. The system of claim 18, wherein the processor is operative to:
determine whether the first reserve memory has been released in response to a trigger;
determine whether there is sufficient memory available in the event the first reserve memory has been released; and
reserve another first reserve memory in the event there is sufficient memory available.

21. The system of claim 18, wherein the processor is operative to release the second reserve memory in response to receiving a second memory allocation error.

22. The system of claim 21, wherein the processor is operative to terminate the graphical user interface after saving the musical arrangement.

23. The system of claim 17, wherein the musical arrangement implements a third-party plug-in.

24. The system of claim 17, wherein the displayed musical arrangement includes at least one of an audio file and a MIDI file.
